(19) United States
(12) Patent Application Publication
(10) Pub. No.: US 2025/0209251 A1
(43) Pub. Date: Jun. 26, 2025

(54) SYSTEMS AND METHODS FOR FILTERING TEXT ASSOCIATED WITH LARGE LANGUAGE MODEL (LLM) SYSTEMS

(71) Applicant: Helix, Inc., San Mateo, CA (US)

(72) Inventor: Eduard Grubman, Thousand Oaks, CA (US)

(21) Appl. No.: 18/394,661

(22) Filed: Dec. 22, 2023

(51) Int. Cl. G06F 40/10

(52) U.S. Cl. CPC G06F 40/10

(57) ABSTRACT

Systems and methods are provided for herein beneficially prevent the disclosure of undesirable text being transferred to and from an LLM system. In one embodiment, a system for processing text of a chat window communicatively linked to a Large Language Model (LLM) system. The system includes a digital memory operable to buffer one or more of a plurality of text strings from a user interacting with the chat window. The system also includes a moderation engine operable to, when the one or more buffered text strings approaches a buffer size of the digital text buffer, apply a plurality of rules to the digital memory, and to trigger an action in the chat window that prevents at least one of the one or more buffered text strings from being transferred to the LLM system.

### FIELD

The disclosure relates to the field of Large Language Model (LLM) systems, and in particular, to mediating interactions between LLMs and users.

### BACKGROUND

A large language model works by using a deep neural network to process and generate human-like text. LLMs are generally built using a type of neural network called a “transformer.” The transformer is designed to handle sequential data, making it well-suited for natural language processing tasks. LLMs are often trained on massive datasets of text from the internet, including books, articles, websites, and more. The LLM learns patterns, grammar, and context of the language from this text.

Existing LLM interactions typically involve a user providing a prompt (e.g., a question or other statement entered through a chat window on the internet) to an LLM system. When the user provides the prompt, the LLM system attempts to generate a response. In doing so, the LLM system may predict words that would be considered most likely to follow the prompt of the user. Unfortunately, many LLM system require a vast amount of processing power to operate. This means that a response may take a substantial amount of time to generate via an LLM system.

Current solutions to these timing concerns involve “live-streaming” prompt data to an LLM system. In some instances, the contents of a prompt or response are inappropriate for the intended purpose of the LLM system. These inappropriate prompts can be logged and stored at the operator of the LLM system, and then inadvertently used to train the LLM system, potentially becoming integrated into the LLM system and reducing the quality of the LLM system. Similarly, an inappropriate response from an LLM system may be provided to a user and may linger within a chat window, resulting in misinformation being presented to the user.

### SUMMARY

Embodiments described herein beneficially prevent the disclosure of undesirable text being transferred to and from an LLM system.

One embodiment is a method for processing text of a chat window communicatively linked to a LLM system. The method includes receiving characters from a user interacting with the chat window, and accumulating one or more of the characters in memory to form a text comprising one or more strings. When at least one of the strings changes length, the method includes processing the strings through a moderation engine, and triggering an action in the chat window via the moderation engine that prevents at least one of the strings from being transferred to the LLM system.

A further embodiment includes a system for processing text of a chat window communicatively linked to a LLM system. The system includes a memory operable to accumulate characters from a user interacting with the chat window to form a text comprising one or more strings. The system also includes a moderation engine operable to, when at least one of the strings changes length, apply a plurality of rules to the strings, and to trigger an action in the chat window that prevents at least one of the strings from being transferred to the LLM system.

Other illustrative embodiments (e.g., methods and computer-readable media relating to the foregoing embodiments) may be described below. The features, functions, and advantages that have been discussed can be achieved independently in various embodiments or may be combined in yet other embodiments, further details of which can be seen with reference to the following description and drawings.

### DESCRIPTION OF THE DRAWINGS

Some embodiments of the present disclosure are now described, by way of example only, and with reference to the accompanying drawings. The same reference number represents the same element or the same type of element on all drawings.

FIG. 1A is a block diagram of a system operable to trigger an action in a chat window interacting with an LLM system in an illustrative embodiment.

FIG. 1B illustrates exemplary user prompts and actions.

FIG. 2 is a flowchart depicting a method of processing strings of a chat window in an illustrative embodiment.

FIG. 3 is a block diagram of another system operable to trigger an action in a chat window interacting with an LLM system in an illustrative embodiment.

FIGS. 4 and 5 are flowcharts depicting additional methods of processing strings in an illustrative embodiment.

FIG. 6 depicts an illustrative computing system operable to execute programmed instructions embodied on a computer readable medium.

### DESCRIPTION

The figures and the following description depict specific illustrative embodiments of the disclosure. It will thus be appreciated that those skilled in the art will be able to devise various arrangements that, although not explicitly described or shown herein, embody the principles of the disclosure and are included within the scope of the disclosure. Furthermore, any examples described herein are intended to aid in understanding the principles of the disclosure, and are to be construed as being without limitation to such specifically recited examples and conditions. As a result, the disclosure is not limited to the specific embodiments or examples described below, but by the claims and their equivalents.

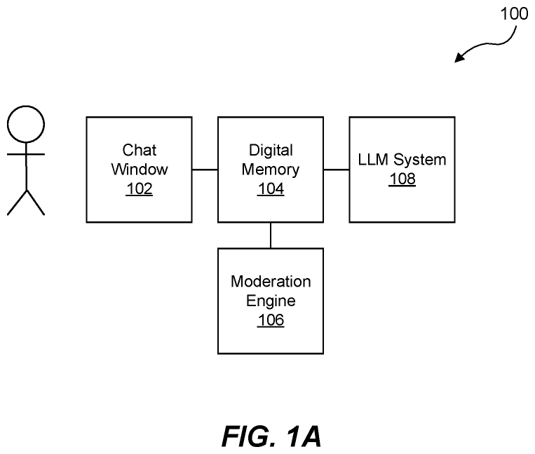

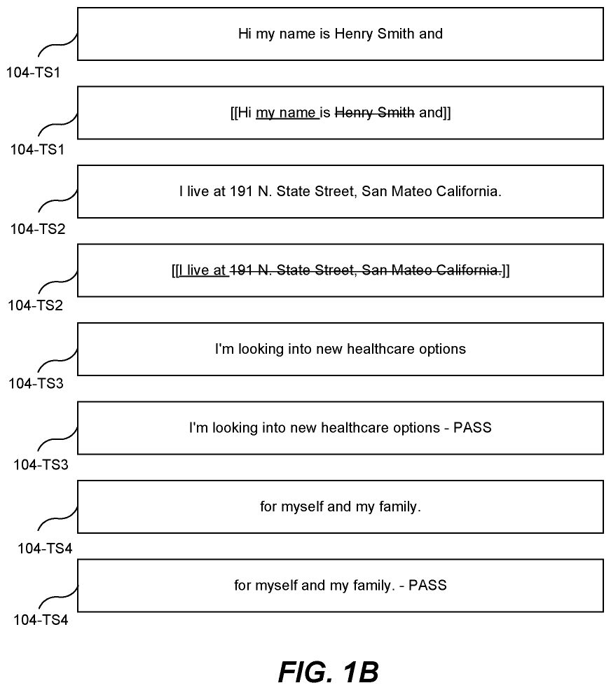

FIG. 1A is a block diagram of a system 100 operable to trigger an action in a chat window 102 interacting with an LLM system 108 in an illustrative embodiment. The system 100 includes a digital memory 104 and a moderation engine 106. The digital memory 104 is communicatively coupled to the chat window 102. The chat window 102 is similar to any chat window one might find on various interactive websites on the Internet. For example, the chat window 102 may be implemented via a code executed by a web browser that creates a Graphical User Interface (GUI) element for providing textual input to a listener service. In this regard, a user may enter text through the chat window 102 where it is received by the digital memory 104. The digital memory 104 accumulates characters from the user interacting with the chat window 102 into a text comprising one or more strings. The moderation engine 106 is operable to, when at least one of the strings changes in length, apply a plurality of rules to the strings in digital memory 104. That is, the moderation engine 106 may search for and detect any of a plurality of words or phrases from the user, such as profanities, Personally Identifiable Information (PII) of a user, and/or Personal Health Information (PHI) of the user. If the moderation engine 106 detects any of these words or phrases, the moderation engine 106 triggers an action in the chat window 102 that prevents at least one of the strings from being transferred to the LLM system 108.

Based on the foregoing, the digital memory 104 is any device, system, software, or combination thereof operable to receive strings over a communication link and temporarily retain the strings until the strings can be processed by the moderation engine 106. The moderation engine 106 is any device, system, software, or combination thereof operable to store and apply plurality of rules to strings in the digital memory 104 before they are transferred to the LLM system 108. To illustrate, a user may enter the string “Hi my name is Henry Smith and I live at 191 N. State Street, San Mateo California. I'm looking into new healthcare options for myself and my family.” The moderation engine 106 may determine that the strings “Henry Smith” and “191 N. State Street San Mateo California” are PII of the user. The moderation engine 106, upon detecting the PII, may trigger an action in the chat window 102. For example, the moderation engine 106 may highlight the terms in the chat window 102 and indicate that the user should remove those terms, the moderation engine 106 may delete the terms and forward any remaining strings to the LLM system 108, the moderation engine 106 may end the chat session with the user by closing the chat window 102, etc.

The digital memory 104 may be configured of a particular size as a matter of design choice. In some instances, however, the digital memory 104 may buffer portions of text from the chat window 102. Thus, the moderation engine 106 can process smaller portions of the text from the chat window 102 so as to assist in expediting transfer of the text from the chat window 102 to the LLM system 108 in near real-time.

For example, FIG. 1B illustrates the digital memory 104 with the “Henry Smith” example above with portions of the text from the chat window 102 being processed in a piecemeal format. In this example, a user may enter the string “Hi my name is Henry Smith and I live at 191 N. State Street, San Mateo California. I'm looking into new healthcare options for myself and my family” in the chat window 102. The digital memory 104 may accumulate a first portion of this string 104-TS1 and the moderation engine 106 may detect the string “my name” followed by the text string “ [symbol] ” and recognize that these strings pertain to PII of the user. The moderation engine 106 may then strike the string “Henry Smith” in the chat window 102 and/or strike the entirety of the text string 104-TS1 “Hi my name is Henry Smith and” from the digital memory 104.

Next, the digital memory 104 may accumulate characters for the string 104-TS2 “I live at 191 N. State Street, San Mateo California.” and the moderation engine 106 may detect the text string “I live at” followed by the text string “191 N. State Street, San Mateo California” and recognize that this text string also pertains to PII of the user. The moderation engine 106 may then strike the string “ [symbol] [symbol] ” in the chat window 102 and/or strike the entirety of the string 104-TS2 (e.g., “I live at 191 N. State Street, San Mateo California.”) from the digital memory 104. Next, digital memory 104 may accumulate characters for the string 104-TS3 “I′m looking into new healthcare options”. The moderation engine 106 may recognize that the string 104-TS3 does not contain any PII of the user, and allow the string 104-TS3 to pass, in which case the moderation engine 106 may allow the string 104-TS3 to be transferred to the LLM system 108. Then, the digital memory 104 may further accumulate characters for the string 104-TS4 “for myself and my family.” The moderation engine 106 may also recognize that the string 104-TS4 does not contain any PII of the user, and allow the text string 104-TS4 to pass, in which case the moderation engine 106 also may allow the string 104-TS4 to be transferred to the LLM system 108.

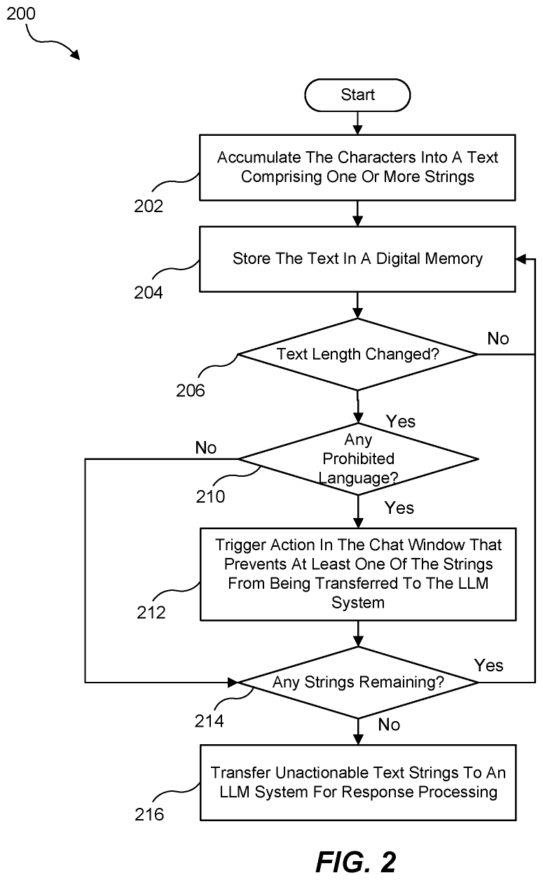

FIG. 2 is a flowchart depicting a method 200 of processing strings of a chat window 102 in an illustrative embodiment. In this embodiment, the process starts when a user begins interacting with the chat window 102 to input characters through the chat window 102. The digital memory 104 accumulates the characters into a text comprising one or more strings, in the process element 202. As used herein, a character may comprise any of multiple possible alphanumeric codes in accordance with a known format, such as the Unicode Transformation Format-8-bit (UTF-8) format, the Unicode Standard format, etc.

The digital memory 104 may store the text, in the process element 204. From there, the moderation engine 106 determines whether at least one of the strings of the text has changed in length, in the process element 206. The determination may be performed in a number of ways. For example, in embodiments where the text comprises a single string, and addition or deletion of characters from that string may result in this conclusion. In a further embodiment where the text is segmented into strings that each comprises a set of characters separated by a marker (e.g., periods or line breaks), the addition of a new marker, or the addition or deletion of a character within any already-defined string, may trigger this determination. If none of the strings have changed in length, the digital memory 104 continues to store the text.

From there, the moderation engine 106 may determine whether any contents of the strings of the text are prohibited (e.g., PHI, PII, obscenities, etc.), in the process element 210. The detection of prohibited text may be performed directly via Natural Language Processing (NLP) techniques (e.g., for identifying patterns of numbers that represent telephone numbers or Social Security Numbers (SSNs), identifying addresses and names, etc.), may be performed by an alternative LLM system that does not retain submitted information for training purposes, or any other suitable system. If the contents of any string are prohibited, the moderation engine 106 may trigger an action in the chat window 102 that prevents at least one of the strings from being transferred (e.g., in whole or in part, such as the prohibited part) to the LLM system 108, in the process element 212. For example, the moderation engine 106 may strike language in the chat window 102, close the chat window 102 (e.g., automatically terminate a connection by interrupting a session between the user and the chat window), alert the user that the language is not allowed in the chat window 102 (e.g., automatically generate a response highlighting strings to be extracted), etc. Then, the moderation engine 106 may determine whether any strings remain in the chat window 102, in the process element 214. Alternatively, if the language currently stored in the digital memory 104 is not prohibited in process element 210, the moderation engine 106 may directly proceed to determining whether any text remains in the chat window 102, in the process element 214.

If any text remains in the chat window 102, the moderation engine 106 may direct the digital memory 104 to continue to accumulate new characters, in the process element 204. Once all of the text from the chat window 102 has been processed by the moderation engine 106, the moderation engine 106 may transfer any unactionable text strings to the LLM system 108 for response processing, in the process element 216. For example, in order to facilitate a quick response by the LLM system 108, an “onChange event” may provide an asynchronous call to the LLM system 108 as the user types. An onChange event is a JavaScript event that occurs when the value of an HTML (Hyper Text Markup Language) element is changed. The onChange event may be used with form elements such as text boxes, dropdown menus, and checkboxes. When the value of an element changes, the onChange event is triggered, and a JavaScript function can be executed. Such may result in transferring unactionable text strings in real time as they are processed by the moderation engine 106, or by the moderation engine 106 concatenating all of the unactionable text strings after processing for transfer to the LLM system 108.

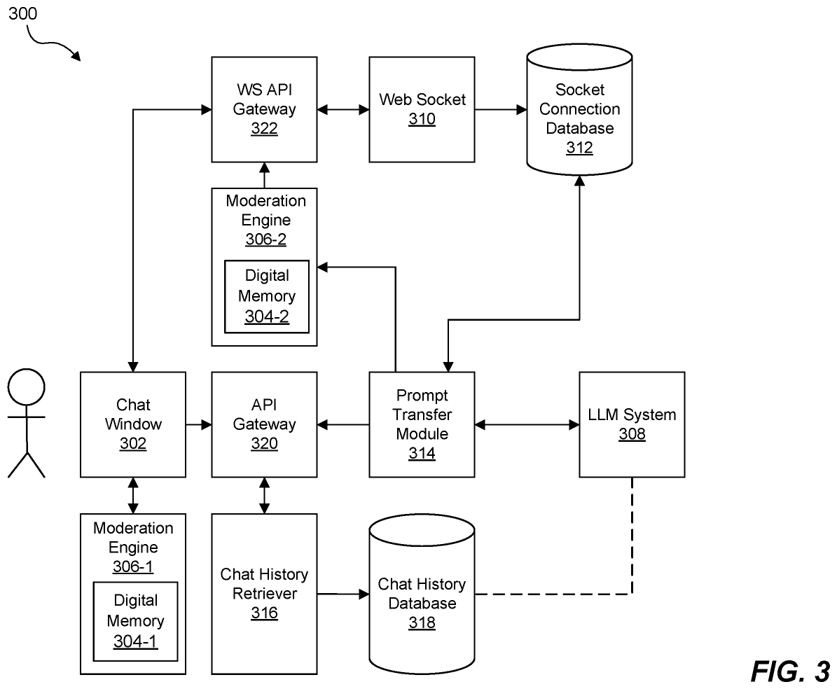

FIG. 3 is a block diagram of network 300 comprising moderation engines 306-1 and 306-2 operable with a chat window 302 and an LLM system 308, respectively, in an illustrative embodiment. The network 300 comprises a plurality of modules that allow the chat window 302 to transfer text exchanges between the chat window 302 and the LLM system 308. For example, the network 300 may include a web socket (WS) application programming interface (API) gateway 322, a web socket 310, a socket connection database 312, an API Gateway 320, a prompt transfer module 314, a chat history retriever 316, and a chat history database 318.

The WS API gateway 322 is generally a software component that acts as an intermediary between clients and backend services, such as web applications. An API gateway provides centralized management of API communication, such as security, authentication, authorization, traffic control, monitoring, versioning, data transformation, caching, load balancing, and protocol translation. The WS API gateway 322 generally simplifies the development and deployment of distributed applications, especially in cloud environments. The WS API Gateway 322 can also improve the performance, scalability, and reliability of the backend services by reducing a number of requests and handling errors.

The WS API gateway 322 is communicatively coupled to the chat window 302 and the web socket 310. The web socket 310 comprises a computer communications protocol, providing simultaneous two-way communication channels over a single Transmission Control Protocol (TCP) connection. The protocol of the web socket 310 enables full-duplex interaction between a web browser (e.g., implementing the chat window 302) and a web server, facilitating real-time data transfer to and from the server.

When a user opens the chat window 302, the WS API gateway 322 opens a connection, which is transferred to the web socket 310 for storage in the socket connection database 312. That is, once the connection in the chat window 302 is established, the connection can be instantiated by the user ID of the user communicating through the chat window 302 such that future connections with the user can be quickly established.

When the user starts communicating in the chat window 302 via text, the strings are transferred to the WS API gateway 322 through the web socket 310 and the socket connection database 312 to the prompt transfer module 314. The prompt transfer module 314 transfers strings as a text prompt to the LLM system 308 such that the LLM system 308 can generate an appropriate response to the user through the chat window 302. First, however, the moderation engine 306-1 buffers the text that the user enters through the chat window 302 via the digital memory 304-1 as described hereinabove, and applies rules to the buffered text to trigger an action in the chat window 302 (e.g., remove PII of the user, PHI of the user, profanities of the user, etc.). Assuming that the moderation engine 306-1 approves text from the user in the chat window 302, the moderation engine 306-1 directs the chat window 302 to transfer the approved text to the prompt transfer module 314 via the WS API gateway 322, the web socket 310, and the socket connection database 312. And the prompt transfer module 314, in turn, transfers the approved text to the LLM system 308 to generate an appropriate response.

When the LLM system 308 generates a response to the text of the user that is provided as a prompt, the LLM system 308 transfers the text to the chat window 302 by retrieving the connection from the socket connection database 312 (e.g., the connection instantiated with the user ID of the user in the socket connection database 312).

Before being transferred to the chat window 302, the moderation engine 306-2 may store the text from the LLM system 308 in a digital memory 304-2 such that the moderation engine 306-2 can strip any unauthorized text from the LLM system 308. For example, the LLM system 308, being trained on a large number of chat histories in the chat window 302, can inadvertently deliver inappropriate responses to the user in the chat window 302. The moderation engine 306-2 may buffer the responses from the LLM system 308 and remove any inappropriate text from the LLM system 308, in a manner similar to the handing of user text entered via the chat window 302. Once the moderation engine 306-2 approves the buffered text from the LLM system 308, the moderation engine 306-2 transfers the text to the WS API gateway 322 for conveyance to the chat window 302.

The network 300 may also include another API gateway 320, a chat history retriever 316, and a chat history database 318. The API gateway 320 is communicatively coupled to the chat window 302 and the prompt transfer module 314. The API gateway 320 provides a simplex communication path from the chat window 302 and the prompt transfer module 314. That is, the API gateway 320 receives text that has been processed by the moderation engine 306-1 as well as text from the LLM system 308 of the prompt transfer module 314. The API gateway 320 transfers the text from the chat window 302 and the LLM system 308 on a connection-by-connection basis. That is, when the user conducts a session with the chat window 302, text that is transferred from the chat window 302 to the LLM system 308 is recorded by the chat history retriever 316. Similarly, text from the LLM system 308 to the chat window 302 is recorded during that session. The chat history retriever 316 thus records all texts in a session and stores that session information in the chat history database 318 on a connection-by-connection basis. In some embodiments, the chat history database 318 may be communicatively coupled to the LLM system 308 for use and further training of the LLM system 308.

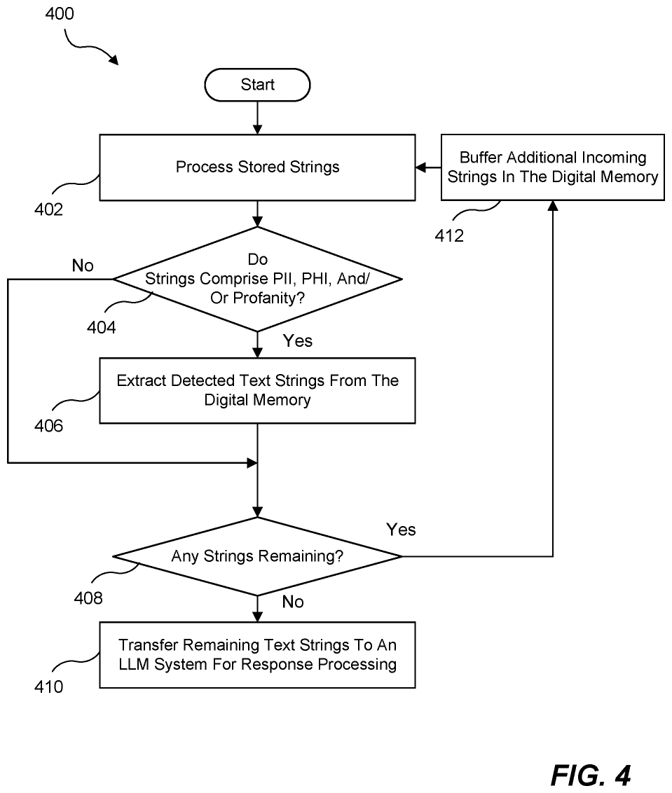

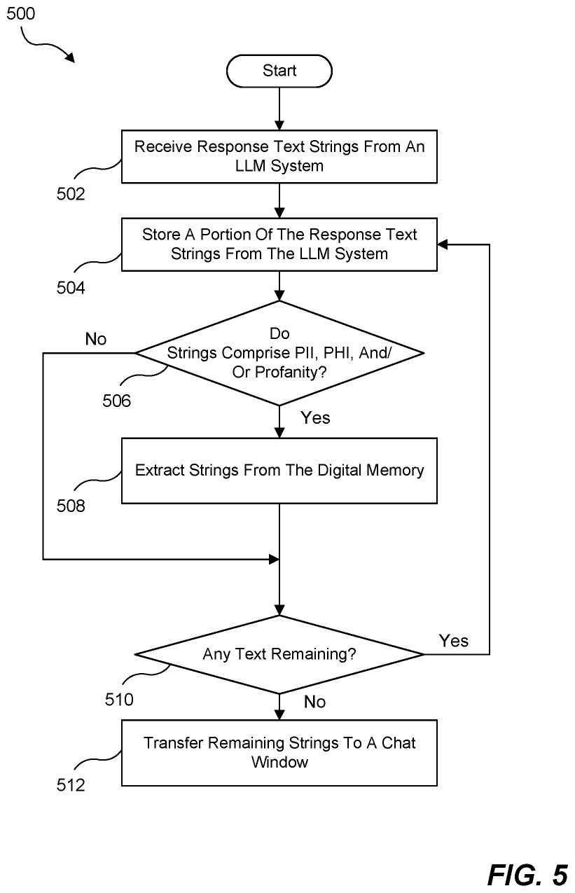

FIGS. 4 and 5 are flowcharts depicting additional methods of processing text strings in an illustrative embodiment. More specifically, FIG. 4 illustrates a process 400 of a moderation engine, such as moderation engine 106 of FIG. 1A, for transferring processed text from a chat window, such as the chat window 102 of FIG. 1A. In this embodiment, the process 400 initiates when strings are stored in a digital memory, such as the digital memory 104 of FIG. 1A. The moderation engine may processes the text as described above, and/or by buffering portions of the text in the memory (e.g., by buffering a portion of the incoming text, processing the buffered text, buffering another portion of the incoming text, processing that buffered text, etc.).

In this regard, the moderation engine processes the strings, in the process element 402, to determine whether the strings comprise any PII, PHI, profanity, and/or any other text deemed actionable. If the strings do include such information (process element 404), the moderation engine extracts the detected offending strings from the digital text memory, in the process element 406, and then determines whether any incoming text remains, in the process element 408. If there are no offending strings in the digital memory, then the moderation engine progresses to the process element 408 to determine whether any incoming strings remain. If additional strings do remain, the moderation engine directs the digital memory to buffer additional incoming strings, in the process element 412, for rules processing in the process element 402. If no other incoming strings remain, the moderation engine, after extracting any offending text strings, may then transfer any remaining text strings to an LLM system, such as the LLM system 108 of FIG. 1A, for response processing, in the process element 410.

FIG. 5 illustrates a process 500 of the moderation engine for processing text from an LLM system, such as the LLM system 108 of FIG. 1A. In this embodiment, the moderation engine (e.g., moderation engine 106 of FIG. 1A) receives a response of text strings from the LLM system, in the process element 502. Like with the chat window side of buffering and processing described hereinabove, the moderation engine directs a digital memory to store a portion of the response from the LLM as strings, in the process element 504. The moderation engine processes the strings to determine whether the strings comprise any PII, PHI, and/or profanity, in the process element 506. If the strings from the LLM system do comprise such language, the moderation engine extracts the strings from the digital memory, in the process element 508. The moderation engine then determines whether any text remains, in the process element 510, and if so, the moderation engine directs the digital memory to accumulate additional strings from the LLM system, in the process element 504.

If the moderation engine determines that the strings of the digital memory do not comprise any PII, PHI, and/or profanity (i.e., the process element 506), then the moderation engine determines whether any text remains from the LLM system, in the process element 510. Once all text from the LLM system has been processed, the moderation engine may transfer the remaining strings to the chat window for display, in the process element 512. That is, the moderation engine may transfer all text from the LLM system minus the extracted text due to PII, PHI, and/or profanity, and transfer that text to the LLM system for response processing.

Any of the various computing and/or control elements shown in the figures or described herein may be implemented as hardware, as a processor implementing software or firmware, or some combination of these. For example, an element may be implemented as dedicated hardware. Dedicated hardware elements may be referred to as “processors,” “controllers,” or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

In one embodiment, instructions stored on a computer readable medium direct a computing system of any of the devices and/or servers discussed herein to perform the various operations disclosed herein. In some embodiments, all or portions of these operations may be implemented in a networked computing environment, such as a cloud computing system. Cloud computing often includes on-demand availability of computer system resources, such as data storage (cloud storage) and computing power, without direct active management by a user. Cloud computing relies on the sharing of resources, and generally includes on-demand self-service, broad network access, resource pooling, rapid elasticity, and measured service.

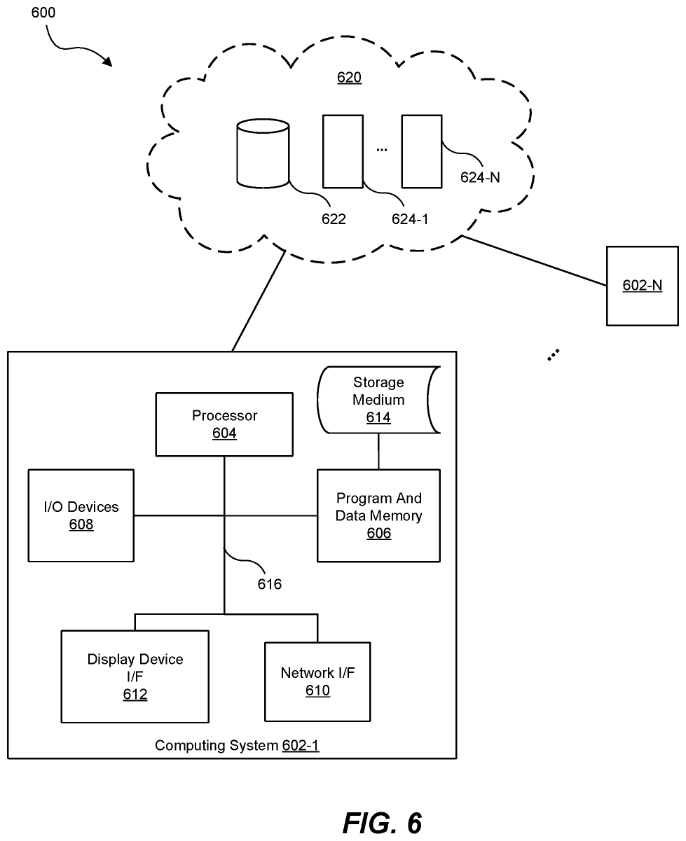

FIG. 6 depicts one illustrative cloud computing system 600 operable to perform the above operations by executing programmed instructions tangibly embodied on one or more computer readable storage mediums. The cloud computing system 600 generally includes the use of a network of remote servers hosted on the internet to store, manage, and process data, rather than a local server or a personal computer (e.g., in the computing systems 602-1-602-N). Cloud computing enables users to use infrastructure and applications via the internet, without installing and maintaining them on-premises. In this regard, the cloud computing network 620 may include virtualized information technology (IT) infrastructure (e.g., servers 624-1-624-N, the data storage module 622, operating system software, networking, and other infrastructure) that is abstracted so that the infrastructure can be pooled and/or divided irrespective of physical hardware boundaries. In some embodiments, the cloud computing network 620 can provide users with services in the form of building blocks that can be used to create and deploy various types of applications in the cloud on a metered basis.

Various components of the cloud computing system 600 may be operable to implement the above operations in their entirety or contribute to the operations in part. Some embodiments disclosed herein may utilize instructions (e.g., code/software) accessible via a computer-readable storage medium for use by various components in the cloud computing system 600 to implement all or parts of the various operations disclosed hereinabove. Examples of such components include the computing systems 602-1-602-N.

Exemplary components of the computing systems 602-1-602-N may include at least one processor 604, a computer readable storage medium 614, program and data memory 606, input/output (I/O) devices 608, a display device interface 612, and a network interface 610. For the purposes of this description, the computer readable storage medium 614 comprises any physical media that is capable of storing a program for use by the computing system 602. For example, the computer-readable storage medium 614 may be an electronic, magnetic, optical, electromagnetic, infrared, semiconductor device, or other non-transitory medium. Examples of the computer-readable storage medium 614 include a solid-state memory, a magnetic tape, a removable computer diskette, a random access memory (RAM), a read-only memory (ROM), a rigid magnetic disk, and an optical disk. Some examples of optical disks include Compact Disk-Read Only Memory (CD-ROM), Compact Disk-Read/Write (CD-R/W), Digital Versatile Disc (DVD), and Blu-Ray Disc.

The processor 604 is coupled to the program and data memory 606 through a system bus 616. The program and data memory 606 include local memory employed during actual execution of the program code, bulk storage, and/or cache memories that provide temporary storage of at least some program code and/or data in order to reduce the number of times the code and/or data are retrieved from bulk storage (e.g., a hard disk drive, a solid state drive, or the like) during execution.

Input/output or I/O devices 608 (including but not limited to keyboards, displays, touchscreens, microphones, pointing devices, etc.) may be coupled either directly or through intervening I/O controllers. Network adapter interfaces 610 may also be integrated with the system to enable the computing system 602 to become coupled to other computing systems or storage devices through intervening private or public networks. The network adapter interfaces 610 may be implemented as modems, cable modems, Small Computer System Interface (SCSI) devices, Fibre Channel devices, Ethernet cards, wireless adapters, etc. Display device interface 612 may be integrated with the system to interface to one or more display devices, such as screens for presentation of data generated by the processor 604.

What is claimed is:

1. A method for processing text of a chat window communicatively linked to a Large Language Model (LLM) system, the method comprising:
receiving a plurality of characters from a user interacting with the chat window;
accumulating one or more of the characters in memory to form a text comprising one or more strings;
when at least one of the strings changes length, processing the strings through a moderation engine; and
triggering an action in the chat window via the moderation engine that prevents at least one of the strings from being transferred to the LLM system.

2. The method of claim 1, further comprising:
extracting at least one of the strings from the text based on the action, as the user interacts with the chat window; and
transferring remaining strings of the text from the chat window to the LLM system to initiate response processing.

3. The method of claim 1, further comprising at least one of:
processing the action to automatically interrupt a session between the user and the chat window; or
processing the action to automatically generate a response to the user highlighting any extracted strings.

4. The method of claim 1, further comprising:
processing a response provided by the LLM system through the moderation engine to extract one or more strings from the response.

5. The method of claim 1, further comprising:
receiving new characters via interactions of the user with the chat window, resulting in a new text comprising new strings; and
when at least one of the new strings changes length, processing the new strings through the moderation engine to extract at least one of the new strings from the new text, and transferring remaining new strings from the new text to the LLM system for response processing.

6. The method of claim 1, further comprising:
concatenating the received plurality of characters without any extracted strings; and
transferring the concatenated plurality of characters to the LLM system to generate a response by the LLM system.

7. The method of claim 1, further comprising:
detecting, via the moderation engine, that at least one of the strings comprises at least one of personally identifiable information (PII), personal health information (PHI), or profanity;
extracting the at least one detected string from the text; and
transferring remaining strings of the text from the chat window to the LLM system for response processing.

8. A non-transitory computer readable medium embodying programmed instructions which, when executed by a processor, are operable for performing a method for processing text of a chat window communicatively linked to a Large Language Model (LLM) system, the method comprising:
receiving a plurality of characters from a user interacting with the chat window;
accumulating one or more of the characters in memory to form a text comprising one or more strings;
when at least one of the strings changes length, processing the strings through a moderation engine; and
triggering an action in the chat window via the moderation engine that prevents at least one of the strings from being transferred to the LLM system.

9. The computer readable medium of claim 8, further comprising instructions which, when executed by the processor, are operable for:
extracting at least one of the strings from the text based on the action, as the user interacts with the chat window; and
transferring remaining strings of the text from the chat window to the LLM system to initiate response processing.

10. The computer readable medium of claim 8, further comprising instructions which, when executed by the processor, are operable for, at least one of:
processing the action to automatically interrupt a session between the user and the chat window; or
processing the action to automatically generate a response to the user highlighting any extracted strings.

11. The computer readable medium of claim 8, further comprising instructions which, when executed by the processor, are operable for:
processing a response provided by the LLM system through the moderation engine to extract one or more strings from the response.

12. The computer readable medium of claim 8, further comprising instructions which, when executed by the processor, are operable for:
receiving new characters via interactions of the user with the chat window, resulting in a new text comprising new strings; and
when at least one of the new strings changes length, processing the new strings through the moderation engine to extract at least one of the new strings from the new text, and transferring remaining new strings from the new text to the LLM system for response processing.

13. The computer readable medium of claim 8, further comprising instructions which, when executed by the processor, are operable for:
concatenating the received plurality of characters without any extracted strings; and
transferring the concatenated plurality of characters to the LLM system to generate a response by the LLM system.

14. The computer readable medium of claim 8, further comprising instructions which, when executed by the processor, are operable for:
detecting, via the moderation engine, that at least one of the strings comprises at least one of personally identifiable information (PII), personal health information (PHI), or profanity;
extracting the at least one detected string from the text; and
transferring remaining strings of the text from the chat window to the LLM system for response processing.

15. A system for processing text of a chat window communicatively linked to a Large Language Model (LLM) system, the system comprising:
a memory operable to accumulate characters from a user interacting with the chat window to form a text comprising one or more strings; and
a moderation engine operable to, when at least one of the strings changes length, apply a plurality of rules to the strings, and to trigger an action in the chat window that prevents at least one of the one or more strings from being transferred to the LLM system.

16. The system of claim 15, wherein the moderation engine is further operable to:
extract at least one of the strings from the text based on the action as the user interacts with the chat window; and
transfer remaining strings of the text from the chat window to the LLM system to initiate response processing.

17. The system of claim 15, wherein the moderation engine is further operable to at least one of:
process the action to automatically interrupt a session between the user and the chat window; or
process the action to automatically generate a response to the user highlighting any extracted strings.

18. The system of claim 15, wherein the moderation engine is further operable to:
process a response provided by the LLM system through the moderation engine to extract one or more strings from the response.

19. The system of claim 15, wherein:
the memory is further operable to accumulate additional characters from interactions of the user with the chat window, resulting in a new text comprising new strings; and
when the one of the new strings changes length, the moderation engine is further operable to process the new strings to extract at least one of the new strings from the new text, and to transfer remaining new strings from the text to the LLM system for response processing.

20. The system of claim 15, wherein the moderation engine is further operable to:
detect that at least one of the strings comprises at least one of personally identifiable information (PII), personal health information (PHI), or profanity;
extract the at least one detected string from the text; and
transfer remaining strings of the text from the chat window to the LLM system for response processing.
